(19) United States
(12) Patent Application Publication
(10) Pub. No.: US 2024/0428320 A1
(43) Pub. Date: Dec. 26, 2024

(54) IDENTIFYING AN ANOMALOUS TRANSACTION BY COMPARING A METRIC FOR THE TRANSACTION AGAINST A MODEL-DERIVED EXPECTED DISTRIBUTION OF THE METRIC

(71) Applicant: Maplebear Inc. (dba Instacart), San Francisco, CA (US)

(72) Inventors: Rebecca Riso, Croton-On-Hudson, NY (US); Bo Xu, San Francisco, CA (US); Kenneth Jason Sanchez, Orange, CA (US); Ashish Sinha, Jersey City, NJ (US); Chencheng Wu, Los Altos, CA (US)

(21) Appl. No.: 18/213,756

(22) Filed: Jun. 23, 2023

(51) Int. Cl. G06Q 30/0601; G06Q 20/40

(52) U.S. Cl. CPC G06Q 30/0635; G06Q 20/4016

(57) ABSTRACT

An online system receives a request to confirm a transaction that is associated with an order. The system accepts or declines the transaction based on whether an amount associated with the pending transaction is likely to exceed an expected amount of the order by more than a threshold value. To determine the threshold, the system trains a first model to predict an overspend for an order and then trains a second model to predict an amount of error associated with the predictions from the first model. The outputs of the first model and the second model provide a mean and a variance for an expected distribution of the overspend. If the actual overspend amount for the transaction exists in too high of a percentile of the distribution, the transaction may be flagged for review or declined.

### BACKGROUND

This disclosure relates generally to computer hardware and software for modeling predicted distributions. More particularly, the disclosure relates to using machine learning models to predict distributions of possible transaction overspend to identify unexpectedly high overspend.

In current online systems and mobile applications, a customer creates an order of items to be purchased from a retailer. The online system may then facilitate pickup of the items at a retailer and delivery of the items to the customer. Based on the items in the order, the online system can approximate the cost of the order ahead of time. However, the actual cost of the order may not be the same as the expected cost. The total cost of an order may vary for many reasons including adjusted taxes, price changes, bag fees, item substitution, quantity discrepancies, catalog errors, cashiering mistakes, or addition of personal items to an order by a shopper. Although some overspend is expected and accounted for, a system for determining when the overspend is unexpectedly high is needed to prevent loss and fraud.

### SUMMARY

In accordance with one or more aspects of the disclosure, an online system trains and uses machine learning models to identify unexpectedly large order overspend on a transaction. The system accepts or declines the transaction based on whether an amount associated with the pending transaction is likely to exceed an expected amount of the order by more than a threshold value. To determine the threshold, the system trains an overspend prediction model to predict an overspend for an order. The system then trains an error term prediction model to predict an amount of error associated with the predictions from the overspend prediction model.

When order features are provided to the overspend prediction model and the error term prediction model, their respective outputs can be used as a mean and a variance for generating an expected distribution of the overspend for similar transactions. If the actual overspend amount for the transaction exists in too high of a percentile of the distribution, the transaction may be flagged for review or declined.

### BRIEF DESCRIPTION OF THE DRAWINGS

FIG. 1 illustrates an example system environment for an online concierge system, in accordance with one or more embodiments.

FIG. 2 illustrates an example system architecture for an online concierge system, in accordance with one or more embodiments.

FIG. 3 illustrates an example system architecture for a padding control module, in accordance with some embodiments.

FIG. 4A illustrates a process for training an overspend prediction model, in accordance with one or more embodiments.

FIG. 4B illustrates a process for training an error term prediction model, in accordance with one or more embodiments.

FIG. 5 illustrates interactions among modules of the padding control module during deployment, in accordance with one or more embodiments.

FIG. 6 is a flowchart for a method of identifying unexpectedly high overspend in a transaction, in accordance with one or more embodiments.

### DETAILED DESCRIPTION

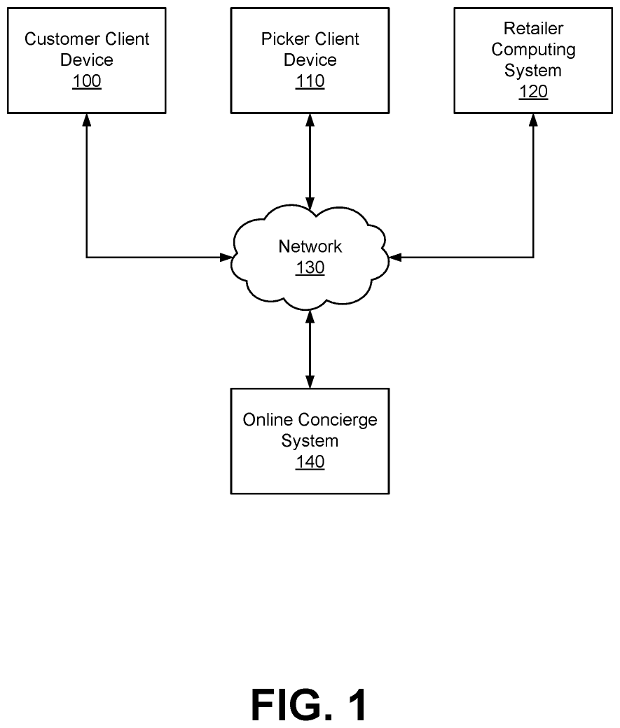

FIG. 1 illustrates an example system environment for an online concierge system 140, in accordance with one or more embodiments. The system environment illustrated in FIG. 1 includes a customer client device 100, a picker client device 110, a retailer computing system 120, a network 130, and an online concierge system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online concierge system 140. Additionally, while one customer client device 100, picker client device 110, and retailer computing system 120 are illustrated in FIG. 1, any number of customers, pickers, and retailers may interact with the online concierge system 140. As such, there may be more than one customer client device 100, picker client device 110, or retailer computing system 120.

The customer client device 100 is a client device through which a customer may interact with the picker client device 110, the retailer computing system 120, or the online concierge system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online concierge system 140.

A customer uses the customer client device 100 to place an order with the online concierge system 140. An order specifies a set of items to be delivered to the customer. An “item”, as used herein, means a good or product that can be provided to the customer through the online concierge system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online concierge system 140. The ordering interface may be part of a client application operating on the customer client device 100. The ordering interface allows the customer to search for items that are available through the online concierge system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online concierge system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online concierge system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online concierge system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item at the retailer, and may even specify a sequence in which the picker should collect the items for improved efficiency in collecting items. In some embodiments, the picker client device 110 transmits to the online concierge system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. When a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the customer client device 100 for display to the customer, so that the customer can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 provides item data indicating which items are available at a particular retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The customer client device 100, the picker client device 110, the retailer computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online concierge system 140 is an online system by which customers can order items to be provided to them by a picker from a retailer. The online concierge system 140 receives orders from a customer client device 100 through the network 130. The online concierge system 140 selects a picker to service the customer's order and transmits the order to a picker client device 110 associated with the picker. The picker collects the ordered items from a retailer location and delivers the ordered items to the customer. The online concierge system 140 may charge a customer for the order and provide portions of the payment from the customer to the picker and the retailer.

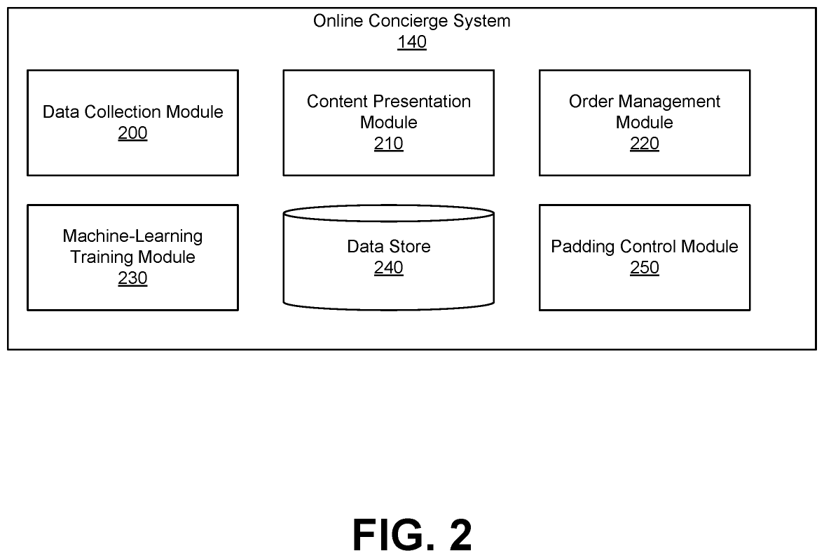

As an example, the online concierge system 140 may allow a customer to order groceries from a grocery store retailer. The customer's order may specify which groceries they want delivered from the grocery store and the quantities of each of the groceries. The customer's client device 100 transmits the customer's order to the online concierge system 140 and the online concierge system 140 selects a picker to travel to the grocery store retailer location to collect the groceries ordered by the customer. Once the picker has collected the groceries ordered by the customer, the picker delivers the groceries to a location transmitted to the picker client device 110 by the online concierge system 140. The online concierge system 140 is described in further detail below with regards to FIG. 2.

FIG. 2 illustrates an example system architecture for an online concierge system 140, in accordance with some embodiments. The system architecture illustrated in FIG. 2 includes a data collection module 200, a content presentation module 210, an order management module 220, a machine-learning training module 230, a data store 240, and a padding control module 250. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online concierge system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online concierge system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online concierge system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In some embodiments, the order data includes user data for users associated with the order, such as customer data for a customer who placed the order or picker data for a picker who serviced the order.

The content presentation module 210 selects content for presentation to a customer. For example, the content presentation module 210 selects which items to present to a customer while the customer is placing an order. The content presentation module 210 generates and transmits an ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine-learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine-learning models and may be stored in the data store 240.

In some embodiments, the content presentation module 210 scores items based on a search query received from the customer client device 100. A search query is free text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

The order management module 220 that manages orders for items from customers. The order management module 220 receives orders from a customer client device 100 and assigns the orders to pickers for service based on picker data. For example, the order management module 220 assigns an order to a picker based on the picker's location and the location of the retailer from which the ordered items are to be collected. The order management module 220 may also assign an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to assign an order to a picker based on a delivery timeframe requested by the customer with the order. The order management module 220 computes an estimated amount of time that it would take for a picker to collect the items for an order and deliver the ordered items to the delivery location for the order. The order management module 220 assigns the order to a picker at a time such that, if the picker immediately services the order, the picker is likely to deliver the order at a time within the requested timeframe. Thus, when the order management module 220 receives an order, the order management module 220 may delay in assigning the order to a picker if the requested timeframe is far enough in the future (i.e., the picker may be assigned at a later time and is still predicted to meet the requested timeframe).

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110, instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of the order. In some embodiments, the order management module 220 computes an estimated time of arrival of the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The machine-learning training module 230 trains machine-learning models used by the online concierge system 140. The online concierge system 140 may use machine-learning models to perform functionalities described herein. Example machine-learning models include regression models, support vector machines, naïve bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, or transformers. A machine-learning model may include components relating to these different general categories of model, which may be sequenced, layered, or otherwise combined in various configurations.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include customer data, picker data, item data, or order data. In some cases, the training examples also include a label which represents an expected output of the machine-learning model. In these cases, the machine-learning model is trained by comparing its output from input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

The data store 240 stores data used by the online concierge system 140. For example, the data store 240 stores customer data, item data, order data, and picker data for use by the online concierge system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

The padding control module 250 manages amounts of overspend that are expected and allowed for transactions to proceed smoothly (i.e., the online concierge system 140 “pads” the allowed expense for an order to include some margin of error). In particular, the padding control module 250 monitors transactions associated with orders to determine whether an actual amount of overspend for a transaction significantly exceeds an expected amount of overspend for that transaction. Overspend is the difference between the actual price of an item at a retailer and the expected price of the item (e.g., based on a catalog listing of the item). The padding control module 250 can evaluate past orders to find instances of unexpected overspend. In some embodiments, the padding control module 250 may evaluate pending transactions and the online concierge system 140 can allow or decline the pending transaction based on whether the overspend significantly exceeds the amount of overspend expected for the order.

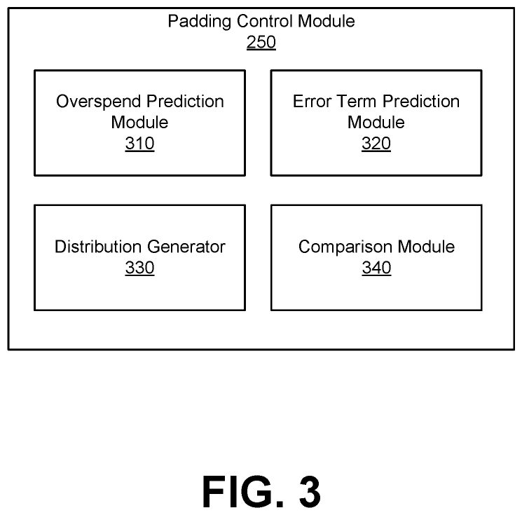

FIG. 3 illustrates an example system architecture for a padding control module 250, in accordance with some embodiments. The system architecture illustrated in FIG. 3 includes an overspend prediction module 310, an error term prediction module 320, a distribution generator 330, and a comparison module 340. Alternative embodiments may include more, fewer, or different components from those illustrated in FIG. 3, and the functionality of each component may be divided between the components differently from the description below. Additionally, each component may perform their respective functionalities in response to a request from a human, or automatically without human intervention.

The overspend prediction module 310 and the error term prediction module 320 analyze sets of order features. Order features may be stored in the data store 240. Order features used by the padding control module 250 include order-specific features like item identification, time of the order, and estimated base price of an item. The order features may also include retailer-specific features, and location-specific features. Examples of retailer-specific features include average tax rates used by the retailer, retailer type, typical overspend at the retailer, and warehouse data. Examples of location-specific features include median tax rate in a geographic area, average fees paid in a geographical area, and location of retailers within an area. In some embodiments, the padding control module 250 analyzes historical order feature sets to identify and flag situations in which unexpectedly high overspend occurred. In other embodiments, the padding control module 250 makes predictions about pending transactions based on incoming order feature data. In most embodiments, the padding control module 250 does not include attributes of individual pickers within the sets of order features because the models used by the padding control module 250 aim to make predictions about legitimate overspend. Therefore, features that might cause models to predict overspend due to fraud are generally excluded.

The overspend prediction module 310 uses a trained machine learning model to predict the overspend that will occur for a given transaction. The overspend prediction module 310 obtains a set of order features associated with an order from the data store 240. The overspend prediction module 310 also accesses parameters of a trained overspend prediction model from the data store 240. The overspend prediction module 310 applies the overspend prediction model to the order features and the model generates a predicted overspend value as output. The predicted overspend is a predicted difference between an expected cost of an order and the actual cost of the order after the order has been affected by things like price fluctuations, tax adjustments, and substituted items.

The error term prediction module 320 uses a second trained machine learning model to generate a predicted error of the overspend prediction module 310 when predicting an overspend for a given transaction. In this way, the error term prediction module 320 generates a value that represents a confidence in the overspend prediction made by the overspend prediction module 310, or a precision of that model, for a particular transaction. Like the overspend prediction module 310, the error term prediction module 320 obtains a set of order features from the data store 240. The error term prediction module 320 also accesses parameters for an error term prediction model from the data store 240. The error term prediction module 320 applies the error term prediction model to the order features. The model outputs a predicted error term associated with the given order feature data. In one embodiment, the predicted error term is a prediction of what the squared error would be for a set of orders similar to the given order feature set. In other embodiments, the error term prediction model may be trained to predict other types of error terms, such as a variance.

The distribution generator 330 uses the outputs from the overspend prediction module 310 and the error term prediction module 320 to generate a distribution. The distribution represents a prediction of a range of overspend values that would occur if many orders having the same characteristics (e.g., as represented by the order features 420) were placed. In one embodiment, the predicted overspend value generated by the overspend prediction module 310 is used as the mean of the distribution and the error term generated by the error term prediction module 320 is used to calculate a variance. These values can be used to determine the normal distribution. In other implementations, different distribution methods may be used.

In one embodiment, instead of using the overspend prediction module 310 and the error term prediction module 320, the padding control module 250 may use a single model that predicts a distribution directly based on order features associated with a transaction. For example, padding control module 250 may use a trained quantile regression model to predict a distribution that represents overspend likelihoods.

The comparison module 340 compares the actual order spend with the distribution from the distribution generator 330. The comparison module 340 determines where the actual order would exist in the distribution. If the order would fall above a specified threshold overspend value, then the comparison module 340 flags the transaction as having an unexpectedly high overspend. In various implementations, the padding control module 250 may set an allowed overspend (padding) value at some percentile of the prediction interval on the distribution, and that value is used as the threshold overspend value. For example, the padding for transaction costs may be set at the upper 99^{th} percentile of the prediction interval. Then, based on the features of a given order, overspend would be expected to be less than x % of the cataloged transaction price 99% of the time, where x is decided by administrators of the online concierge system 140 ahead of time. If a picker attempts a transaction for an amount that exceeds x % of the total order cost, i.e., that falls within the 99^{th} percentile of the generated distribution, then the transaction can be flagged or declined.

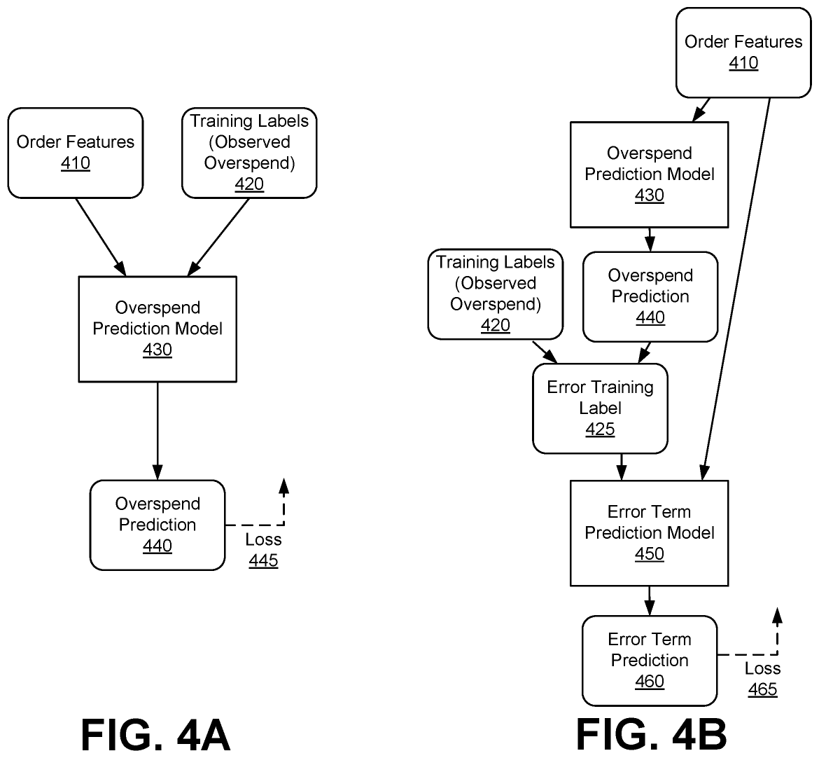

FIG. 4A illustrates a process for training an overspend prediction model 430, in accordance with one or more embodiments. The overspend prediction model 430 is used by the overspend prediction module 310 to predict an overspend value for a given order. The overspend prediction model 430 is trained by the machine-learning training module 230. The parameters for the trained model are stored in the data store 240.

The machine-learning training module 230 accesses training feature data from the data store 240 to train the overspend prediction model 430. The training data includes order features 410 and training labels 420. The order features 410 are sets of feature values for historical orders facilitated by the online concierge system 140. The order features 410 used for training may be the same features used for input into the overspend prediction model 430 during deployment, such as order-specific features, retailer-specific features, and location-specific features of a transaction. The training labels 420 used to train the overspend prediction model 430 include the catalog (i.e., expected) prices associated with items in an order before the sale, and the actual price spent on the order at the retailer. The difference between these values is the actual overspend that occurred for the transaction.

In one embodiment, the overspend prediction model 430 generates an overspend prediction 440 based on the order features 410 provided as input. The machine-learning training module 230 compares the difference between the overspend prediction 440 generated by the overspend prediction model 430 and the actual overspend indicated by the training labels 420 for a transaction. Based on the comparison, the machine-learning training module 230 propagates the loss 445 back through the overspend prediction model 430 to update the model parameters. The training process is repeated with more training data to improve or update the parameters of the overspend prediction model 430.

FIG. 4B illustrates a process for training an error term prediction model 450, in accordance with one or more embodiments. The error term prediction module 310 uses the error term prediction model 450 to predict an error term associated with predictions about overspend on orders similar to the given order. The overspend prediction model 430 is trained by the machine-learning training module 230. The parameters for the trained model are stored in the data store 240.

The machine-learning training module 230 accesses training feature data from the data store 240 to train the error term prediction model 450. As with the process of training the overspend prediction model 430, the training data includes order features 410 that describe historical orders and training labels 420 that indicate the expected transaction costs and the actual costs of the transactions at the time of sale. The machine-learning training module 230 also uses the overspend prediction 440 that is output from the overspend prediction model 430 as a labeled input to the error term prediction model 450 during the model training process. The overspend prediction 440 is needed as an additional input during training for the machine-learning training module 230 to generate the correct error term to apply to the particular output of the overspend prediction model 430.

To train the error term prediction model 450, the machine-learning training module 230 accesses order features 410 and training labels 420 to provide as training input. In one embodiment, the error term prediction model 450 is trained after the overspend prediction model 430 because outputs of the overspend prediction model 430 are used to generate additional training labels to input into the error term prediction model 450 for training. The machine-learning training module 230 inputs the order features 410 into the trained overspend prediction model 430, and the model generates an overspend prediction 440. The machine-learning training module 230 uses the overspend prediction 440 and the training labels 420 to generate an error training label 425 to use as a training label to compare with the output of the error term prediction model 450. For example, in one embodiment, the error training label 425 may be the squared error term and may take the form: [P(overspend)−actual_overspend]², where P(overspend) is the overspend prediction 440 output by the overspend prediction model 430 and actual_overspend is the actual price spent on the item in the historical transaction minus the expected or catalog price of the item for the historical transaction.

The machine-learning training module 230 applies the error term prediction model 450 to the training inputs including the error training label 425 and the order features 410. The error term prediction model 450 generates an error term prediction 460 based on the order features 410. The machine-learning training module 230 compares the difference between the error term prediction 460 generated by the error term prediction model 430 and the error training label 425. Based on the comparison, the machine-learning training module 230 propagates the loss 465 back through the error term prediction model 450 to update the model parameters. The training process is repeated with more training data to improve or update the parameters of the error term prediction model 450.

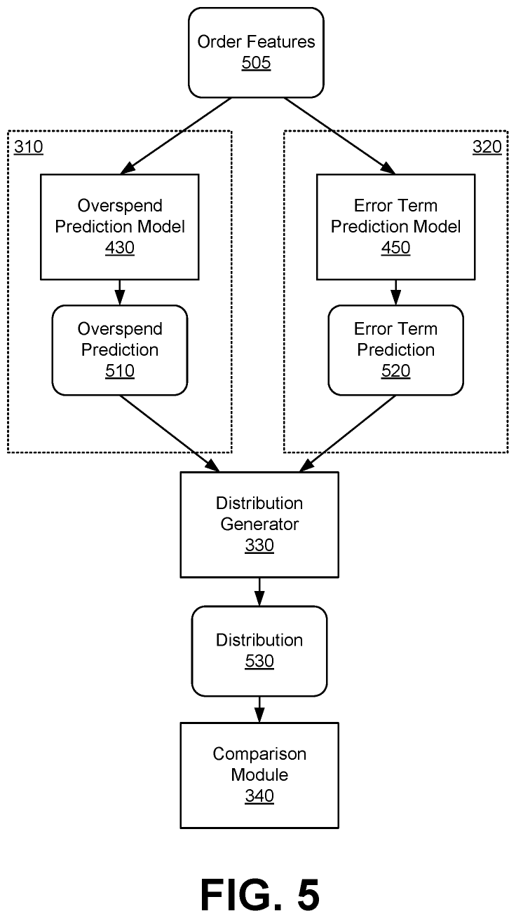

FIG. 5 illustrates interactions among modules of the padding control module 250 during deployment, in accordance with one or more embodiments. To analyze whether a transaction has unexpectedly high overspend, the padding control module 250 obtains order features 505 associated with the transaction. The order features 505 are provided as inputs to the overspend prediction module 310 and the error term prediction module 320. The overspend prediction module 310 uses the trained overspend prediction model 430 to generate an overspend prediction 510 that represents an expected amount of overspend for transactions associated with the order features 505. The error term prediction module 320 uses the trained error term prediction model 450 to generate an error term prediction 520 that represents the predicted error term (e.g., the variance associated with the predicted overspend) for the transaction associated with the order features 505.

The distribution generator 330 uses the overspend prediction 510 and the error term prediction 520 to generate a distribution 530 associated with the predicted overspend on the transaction. The distribution represents a prediction of a range of overspend values that would occur if many orders having the same characteristics (e.g., as represented by the order features 420) were placed. For example, the distribution 530 could be a normal distribution where the overspend prediction 510 is the mean of the distribution and the error term prediction 520 is used as the variance.

The comparison module 340 uses the distribution 530 to determine whether the analyzed transaction should be flagged for unexpectedly high overspend. The comparison module 340 accesses the actual spend that occurred for the transaction. In some cases this information may be stored with the order data for the historical order. In other cases, the online concierge system 140 may be monitoring the overspend amounts on an order in real time, so the comparison module 340 would receive the actual overspend amount when the picker completed the transaction at a retailer. The comparison module 340 determines where the actual overspend value falls in the distribution 530. If the actual overspend value falls within a preset threshold upper percentile of overspend values on the distribution, then the comparison module 340 flags the transaction. The online concierge system 140 may decline flagged transactions or may review the flagged transactions to collect more data about overspend trends.

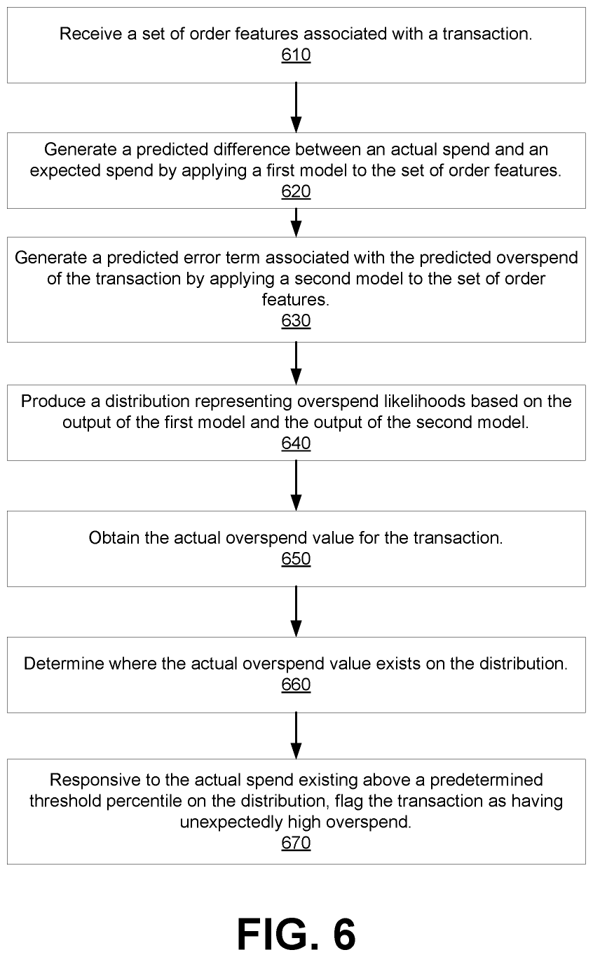

FIG. 6 is a flowchart for a method of identifying unexpectedly high overspend in a transaction, in accordance with some embodiments. Alternative embodiments may include more, fewer, or different steps from those illustrated in FIG. 6, and the steps may be performed in a different order from that illustrated in FIG. 6. These steps may be performed by an online concierge system (e.g., online concierge system 140). Additionally, each of these steps may be performed automatically by the online concierge system without human intervention.

The padding control module 250 monitors and manages overspend padding allowed on transactions facilitated by the online concierge system 140. The padding control module 250 receives 610 a set of order features associated with a transaction. The set of order features may include information about a specific transaction such as a list of items, the expected cost of the items (e.g., based on a retailer catalog), retailer location, and average tax paid at that retailer. The overspend prediction module 310 applies a trained overspend prediction model to the set of order features and generates 620 a predicted difference between the actual spend that will occur in the transaction and the expected spend for the transaction (i.e., the model predicts the overspend amount). The error term prediction module 320 applies a trained error term prediction model to the set of order features to generate 630 a predicted error term associated with the predicted overspend of transactions with those order features.

The distribution generator 330 uses the predicted overspend value and the predicted error term to produce 640 a distribution that represents the overspend likelihoods for transactions similar to the transaction described by the set of order features. Once the distribution has been generated, the comparison module 340 obtains 650 the actual overspend value that occurred for the transaction. The comparison module 340 determines 660 where the actual overspend value exists on the generated distribution. The padding control module 250 may have a predetermined threshold percentile that represents an unexpectedly high overspend amount for a transaction. If the actual spend value exists within this predetermined upper percentile on the distribution, the comparison module 340 may flag 670 the transaction as having an unexpectedly high overspend.

### ADDITIONAL CONSIDERATIONS

Although the present disclosure describes this concept in terms of overspend, there may be other metrics for which an unexpectedly high value of a metric would be indicative of an anomalous or fraudulent transaction. For example, this idea could be applied to return rates across customers, where the customer's history is like the transaction, and the metric would be the customer's historical return rate. As another example, this system could be used to evaluate the time it takes from an employee to complete a task, where the system is used to flag employees who take more than an expected amount of time by more than x standard deviations over the expected overage in time taken.

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated for the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method, performed at a computer system comprising a processor and a computer-readable medium, comprising:
receiving a set of order features associated with a transaction;
generating a predicted overspend value, the predicted overspend value comprising a predicted difference between an actual cost of the transaction and an expected cost of the transaction, wherein generating the predicted overspend value comprises applying a first model to the set of order features;
generating a predicted error term associated with the predicted overspend value of the transaction, wherein generating the predicted error term comprises applying a second model to the set of order features;
producing a distribution that represents likelihoods of amounts of overspend based on the predicted overspend value and the predicted error term;
obtaining an actual overspend value associated with the transaction;
identifying where the actual overspend value associated with the transaction exists on the distribution; and
responsive to identifying that the actual overspend value associated with the transaction exists above a predetermined threshold percentile on the distribution, flagging the transaction as having an unexpectedly high amount of overspend.

2. The method of claim 1, wherein the error term is a predicted squared error term.

3. The method of claim 1, wherein the set of order features does not include features describing attributes or behavior of a picker who selects items for the transaction.

4. The method of claim 1, wherein the set of order features includes retailer-specific features, location-specific features, and order-specific features.

5. The method of claim 1, further comprising declining a flagged transaction.

6. The method of claim 1, wherein the first model is a machine-learned model trained by:
receiving a training set of order features describing a transaction and a corresponding set of training labels that indicate the actual overspend value that occurred for the transaction;
applying parameters of the first model to the set of order features to generate an overspend prediction;
comparing the overspend prediction to the set of training labels; and
updating the first model parameters to account for the comparison.

7. The method of claim 1, wherein the second model is a machine-learned model trained by:
receiving a training set of order features describing a transaction and a corresponding set of training labels that indicate the actual overspend value that occurred for the transaction;
applying the trained first model to the set of order features to generate an overspend prediction;
generating a training error term based on the overspend prediction and the set of training labels;
applying the second model parameters to the order features to generate an error term prediction;
comparing the error term prediction to the training error term; and
updating the second model parameters to account for the comparison.

8. A non-transitory computer-readable storage medium storing instructions that when executed cause a processor to:
receive a set of order features associated with a transaction;
generate a predicted overspend value, the predicted overspend value comprising a predicted difference between an actual cost of the transaction and an expected cost of the transaction, wherein generating the predicted overspend value comprises applying a first model to the set of order features;
generate a predicted error term associated with the predicted overspend value of the transaction, wherein generating the predicted error term comprises applying a second model to the set of order features;
produce a distribution that represents likelihoods of amounts of overspend based on the predicted overspend value and the predicted error term;
obtain an actual overspend value associated with the transaction;
identify where the actual overspend value associated with the transaction exists on the distribution; and
responsive to identifying that the actual overspend value associated with the transaction exists above a predetermined threshold percentile on the distribution, flag the transaction as having an unexpectedly high amount of overspend.

9. The non-transitory computer-readable storage medium of claim 8, wherein the error term is a predicted squared error term.

10. The non-transitory computer-readable storage medium of claim 8, wherein the set of order features does not include features describing attributes or behavior of a picker who selects items for the transaction.

11. The non-transitory computer-readable storage medium of claim 8, wherein the set of order features includes retailer-specific features, location-specific features, and order-specific features.

12. The non-transitory computer-readable storage medium of claim 8, the steps further causing the processor to decline a flagged transaction.

13. The non-transitory computer-readable storage medium of claim 8, wherein the first model is a machine-learned model trained by causing a processor to:
receive a training set of order features describing a transaction and a corresponding set of training labels that indicate the actual overspend value that occurred for the transaction;
apply parameters of the first model to the set of order features to generate an overspend prediction;
compare the overspend prediction to the set of training labels; and
update the first model parameters to account for the comparison.

14. The non-transitory computer-readable storage medium of claim 8, wherein the second model is a machine-learned model trained by causing a processor to:
receive a training set of order features describing a transaction and a corresponding set of training labels that indicate the actual overspend value that occurred for the transaction;
apply the trained first model to the set of order features to generate an overspend prediction;
generate a training error term based on the overspend prediction and the set of training labels;
apply the second model parameters to the order features to generate an error term prediction;
compare the error term prediction to the training error term; and
update the second model parameters to account for the comparison.

15. A computer system comprising:
a computer processor; and
a non-transitory computer-readable storage medium storing instructions that when executed by the computer processor perform actions comprising:
receiving a set of order features associated with a transaction;
generating a predicted overspend value, the predicted overspend value comprising a predicted difference between an actual cost of the transaction and an expected cost of the transaction, wherein generating the predicted overspend value comprises applying a first model to the set of order features;
generating a predicted error term associated with the predicted overspend value of the transaction, wherein generating the predicted error term comprises applying a second model to the set of order features;
producing a distribution that represents likelihoods of amounts of overspend based on the predicted overspend value and the predicted error term;
obtaining an actual overspend value associated with the transaction;
identifying where the actual overspend value associated with the transaction exists on the distribution; and
responsive to identifying that the actual overspend value associated with the transaction exists above a predetermined threshold percentile on the distribution, flagging the transaction as having an unexpectedly high amount of overspend.

16. The computer system of claim 15, wherein the error term is a predicted squared error term.

17. The computer system of claim 15, wherein the set of order features does not include features describing attributes or behavior of a picker who selects items for the transaction.

18. The computer system of claim 15, wherein the set of order features includes retailer-specific features, location-specific features, and order-specific features.

19. The computer system of claim 15, wherein the first model is a machine-learned model trained by:
receiving a training set of order features describing a transaction and a corresponding set of training labels that indicate the actual overspend value that occurred for the transaction;
applying parameters of the first model to the set of order features to generate an overspend prediction;
comparing the overspend prediction to the set of training labels; and
updating the first model parameters to account for the comparison.

20. The computer system of claim 15, wherein the second model is a machine-learned model trained by:
receiving a training set of order features describing a transaction and a corresponding set of training labels that indicate the actual overspend value that occurred for the transaction;
applying the trained first model to the set of order features to generate an overspend prediction;
generating a training error term based on the overspend prediction and the set of training labels;
applying the second model parameters to the order features to generate an error term prediction;
comparing the error term prediction to the training error term; and
updating the second model parameters to account for the comparison.
